(19) United States
(12) Patent Application Publication
(10) Pub. No.: US 2014/0270734 A1
(43) Pub. Date: Sep. 18, 2014

(54) LIGHT IRRADIATION TYPE HEAT TREATMENT APPARATUS AND HEAT TREATMENT METHOD

(71) Applicant: Dainippon Screen MFG. Co., Ltd., Kyoto (JP)

(72) Inventor: Kenichi YOKOUCHI, Kyoto-shi (JP)

(73) Assignee: Dainippon Screen MFG. Co. Ltd., Kyoto (JP)

(21) Appl. No.: 14/177,621

(22) Filed: Feb. 11, 2014

(30) Foreign Application Priority Data
Mar. 13, 2013 (JP) 2013-049960

(51) Int. Cl. H05B 3/00

(52) U.S. Cl. CPC H05B 3/0038
USPC 392/416

(57) ABSTRACT

Four wafer pins are fixed in a chamber and spaced at intervals of 90 degrees. Four support pins are provided in a wafer pocket of a susceptor and spaced at intervals of 90 degrees. The four wafer pins and the four support pins are disposed concyclically in an alternating manner at intervals of 45 degrees. When halogen lamps irradiate a semiconductor wafer with light to heat the semiconductor wafer, the susceptor is moved upwardly and downwardly, so that the semiconductor wafer is shifted between the wafer pins and the support pins. This eliminates the occurrence of a problem such that the quartz pins which are relatively low in temperature are continuously kept in contact with particular places of the semiconductor wafer to improve the uniformity of the in-plane temperature distribution of the semiconductor wafer.

### BACKGROUND OF THE INVENTION

1. Field of the Invention

The present invention relates to a heat treatment apparatus and a heat treatment method for heating a thin plate-like precision electronic substrate such as a semiconductor wafer and a glass substrate for a liquid crystal display device (hereinafter referred to simply as a “substrate”) by irradiating the substrate with light.

2. Description of the Background Art

In the process of manufacturing a semiconductor device, impurity doping is an essential step for forming a pn junction in a semiconductor wafer. At present, it is common practice to perform impurity doping by an ion implantation process and a subsequent annealing process. The ion implantation process is a technique for causing ions of impurity elements such as boron (B), arsenic (As) and phosphorus (P) to collide against the semiconductor wafer with high acceleration voltage, thereby physically implanting the impurities into the semiconductor wafer. The implanted impurities are activated by the subsequent annealing process. When annealing time in this annealing process is approximately several seconds or longer, the implanted impurities are deeply diffused by heat. This results in a junction depth much greater than a required depth, which might constitute a hindrance to good device formation.

In recent years, attention has been given to flash lamp annealing (FLA) that is an annealing technique for heating a semiconductor wafer in an extremely short time. The flash lamp annealing is a heat treatment technique in which xenon flash lamps (the term “flash lamp” as used hereinafter refers to a “xenon flash lamp”) are used to irradiate a surface of a semiconductor wafer with a flash of light, thereby raising the temperature of only the surface of the semiconductor wafer implanted with impurities in an extremely short time (several milliseconds or less).

The xenon flash lamps have a spectral distribution of radiation ranging from ultraviolet to near-infrared regions. The wavelength of light emitted from the xenon flash lamps is shorter than that of light emitted from conventional halogen lamps, and approximately coincides with a fundamental absorption band of a silicon semiconductor wafer. Thus, when a semiconductor wafer is irradiated with a flash of light emitted from the xenon flash lamps, the temperature of the semiconductor wafer can be raised rapidly, with only a small amount of light transmitted through the semiconductor wafer. Also, it has turned out that flash irradiation, that is, the irradiation of a semiconductor wafer with a flash of light in an extremely short time of several milliseconds or less allows a selective temperature rise only near the surface of the semiconductor wafer. Therefore, the temperature rise in an extremely short time with the xenon flash lamps allows only the activation of impurities to be achieved without deep diffusion of the impurities.

A heat treatment apparatus which employs such xenon flash lamps is disclosed in U.S. Patent Application Publication No. 2009/0175605 in which flash lamps are disposed on the front surface side of a semiconductor wafer and halogen lamps are disposed on the back surface side thereof so that a desired heat treatment is performed using a combination of these lamps. In the heat treatment apparatus disclosed in U.S. Patent Application Publication No. 2009/0175605, a semiconductor wafer held on a susceptor is preheated to a certain degree of temperature by the halogen lamps. Thereafter, the temperature of the semiconductor wafer is raised to a desired treatment temperature by flash irradiation from the flash lamps.

In the heat treatment apparatus disclosed in U.S. Patent Application Publication No. 2009/0175605, the semiconductor wafer is placed on a plurality of bumps disposed on the susceptor, and is then subjected to the preheating using the halogen lamps and the flash heating using the flash lamps. The susceptor and the bumps are made of quartz which allows light to pass therethrough. During the preheating using the halogen lamps, the temperature of the susceptor and the bumps which are made of quartz does not increase so much but is accordingly relatively low as compared with the temperature of the semiconductor wafer. As a result, the conduction of heat from the semiconductor wafer to the bumps which are low in temperature occurs to decrease the temperature of portions of a surface of the semiconductor wafer which are in direct contact with the bumps, resulting in the decrease in in-plane temperature distribution of the semiconductor wafer.

### SUMMARY OF THE INVENTION

The present invention is intended for a heat treatment apparatus for heating a substrate by irradiating the substrate with light.

According to one aspect of the present invention, the heat treatment apparatus comprises: a chamber for receiving a substrate therein; a plurality of first support pins for supporting the substrate in the chamber; a susceptor having a plurality of second support pins and for holding the substrate in the chamber; a continuously lighted lamp for irradiating the substrate received in the chamber with light to heat the substrate; a lifting drive for moving the susceptor upwardly and downwardly relative to the first support pins; and a controller configured to control the lifting drive so that a first state and a second state are alternately repeated when the substrate is heated by the irradiation with light from the continuously lighted lamp, the first state being such that the susceptor is in a relatively lowered position so that the first support pins protrude above the second support pins to support the substrate, the second state being such that the susceptor is in a relatively raised position so that the second support pins lie above the first support pins to support the substrate.

The substrate is shifted between the first support pins and the second support pins during the process of heating the substrate by irradiating the substrate with light. This eliminates the occurrence of a problem such that the pins are continuously kept in contact with particular places of the substrate to improve the uniformity of the in-plane temperature distribution of the substrate during the process of heating the substrate by irradiating the substrate with light.

Preferably, the heat treatment apparatus further comprises a pulsed light emitting lamp for irradiating the substrate heated by the continuously lighted lamp with a flash of light, wherein the second support pins have a length less than that of the first support pins, and wherein the controller controls the lifting drive so that the second support pins support the substrate when the substrate is irradiated with a flash of light from the pulsed light emitting lamp.

This prevents the breakage of the second support pins due to an impact to the second support pins during the flash irradiation.

The present invention is also intended for a method of heating a substrate by irradiating the substrate with light.

According to one aspect of the present invention, the method comprises the step of moving a susceptor including a plurality of second support pins upwardly and downwardly relative to a plurality of first support pins provided in a chamber when heating the substrate received in the chamber by irradiating the substrate with light from a continuously lighted lamp, the step of moving the susceptor comprising the substeps of: a) bringing the susceptor in a relatively lowered position so that the first support pins protrude above the second support pins to support the substrate; and b) bringing the susceptor in a relatively raised position so that the second support pins lie above the first support pins to support the substrate, the substep a) and the substep b) being alternately repeated.

The substrate is shifted between the first support pins and the second support pins during the process of heating the substrate by irradiating the substrate with light. This eliminates the occurrence of a problem such that the pins are continuously kept in contact with particular places of the substrate to improve the uniformity of the in-plane temperature distribution of the substrate during the process of heating the substrate by irradiating the substrate with light.

Preferably, the method further comprises the step of irradiating the substrate heated by the continuously lighted lamp with a flash of light from a pulsed light emitting lamp, wherein the second support pins have a length less than that of the first support pins, and wherein the second support pins support the substrate when the substrate is irradiated with a flash of light from the pulsed light emitting lamp.

This prevents the breakage of the second support pins due to an impact to the second support pins during the flash irradiation.

It is therefore an object of the present invention to improve the uniformity of the in-plane temperature distribution of a substrate during the process of heating the substrate by irradiating the substrate with light.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a longitudinal sectional view showing a configuration of a heat treatment apparatus according to the present invention;

FIG. 2 is a plan view of a chamber;

FIG. 3 is a sectional view of a susceptor;

FIG. 4 is a view showing a positional relationship between a plurality of wafer pins and a plurality of support pins of the susceptor;

FIG. 5 is a plan view showing an arrangement of halogen lamps;

FIG. 6 is a flow diagram showing a procedure for treatment of a semiconductor wafer in the heat treatment apparatus of FIG. 1;

FIG. 7 is a view showing a semiconductor wafer transported into the chamber;

FIG. 8 is a view showing a semiconductor wafer supported by the wafer pins;

FIG. 9 is a view showing a semiconductor wafer supported by the support pins of the susceptor; and

FIG. 10 is a view showing another example of the positional relationship between the wafer pins and the support pins of the susceptor.

### DESCRIPTION OF THE PREFERRED EMBODIMENTS

A preferred embodiment according to the present invention will now be described in detail with reference to the drawings.

FIG. 1 is a longitudinal sectional view showing a configuration of a heat treatment apparatus 1 according to the present invention. The heat treatment apparatus 1 according to the present preferred embodiment is a flash lamp annealer for irradiating a disk-shaped semiconductor wafer W serving as a substrate with a flash of light to heat the semiconductor wafer W. The size of the semiconductor wafer W to be treated is not particularly limited. For example, the semiconductor wafer W to be treated has a diameter of 300 mm and 450 mm. The semiconductor wafer W prior to the transport into the heat treatment apparatus 1 is implanted with impurities. The heat treatment apparatus 1 performs a heating treatment on the semiconductor wafer W to thereby activate the impurities implanted in the semiconductor wafer W. An XYZ rectangular coordinate system in which an XY plane is defined as a horizontal plane and a Z axis is defined to extend in a vertical direction is additionally shown in FIG. 1 and the subsequent figures for purposes of clarifying the directional relationship therebetween. Also, the dimensions of components and the number of components are shown in exaggeration or in simplified form, as appropriate, in FIG. 1 and the subsequent figures for the sake of easier understanding.

The heat treatment apparatus 1 includes a chamber 6 for receiving a semiconductor wafer W therein, a flash heating part 5 including a plurality of built-in flash lamps FL, and a halogen heating part 4 including a plurality of built-in halogen lamps HL. The flash heating part 5 is provided over the chamber 6, and the halogen heating part 4 is provided under the chamber 6. The heat treatment apparatus 1 further includes a controller 3 for controlling operating mechanisms provided in the halogen heating part 4, the flash heating part 5, and the chamber 6 to cause the operating mechanisms to heat-treat a semiconductor wafer W.

FIG. 2 is a plan view of the chamber 6. The chamber 6 is configured such that upper and lower chamber windows 63 and 64 made of quartz are mounted to the top and bottom, respectively, of a tubular chamber side wall portion 61 of a substantially rectangular plan configuration. The chamber side wall portion 61 has a generally tubular shape having an open top and an open bottom. The upper chamber window 63 is mounted to block the top opening of the chamber side wall portion 61, and the lower chamber window 64 is mounted to block the bottom opening thereof. The chamber side wall portion 61 is made of a metal material (e.g., stainless steel) with high strength and high heat resistance.

The upper chamber window 63 forming the ceiling of the chamber 6 is a plate-like member made of quartz, and serves as a quartz window that transmits flashes of light emitted from the flash heating part 5 therethrough into the chamber 6. The lower chamber window 64 forming the floor of the chamber 6 is also a plate-like member made of quartz, and serves as a quartz window that transmits light emitted from the halogen heating part 4 therethrough into the chamber 6. An interior space of the chamber 6, i.e. a space surrounded by the upper chamber window 63, the lower chamber window 64 and the chamber side wall portion 61, is defined as a heat treatment space 65.

The chamber side wall portion 61 is provided with a transport opening (throat) 66 disposed on the (+X) side thereof and for the transport of a semiconductor wafer W therethrough into and out of the chamber 6. The transport opening 66 is openable and closable by a gate valve not shown. When the transport opening 66 is opened by the gate valve, a semiconductor wafer W is allowed to be transported through the transport opening 66 into and out of the heat treatment space 65. When the transport opening 66 is closed by the gate valve, the heat treatment space 65 in the chamber 6 is an enclosed space.

The heat treatment apparatus 1 further includes a gas supply part 80 for supplying a treatment gas into the heat treatment space 65 in the chamber 6, and an exhaust part 85 for exhausting gases from the chamber 6. The gas supply part 80 includes a gas supply source 82 and a supply valve 83 which are mounted to a gas supply pipe 81. The gas supply pipe 81 has a distal end in communication with the heat treatment space 65 in the chamber 6, and a proximal end connected to the gas supply source 82. The supply valve 83 is inserted at some midpoint in the gas supply pipe 81. The gas supply source 82 feeds a treatment gas (in this preferred embodiment, nitrogen (N₂) gas) into the gas supply pipe 81. By opening the supply valve 83, the treatment gas is supplied to the heat treatment space 65. The gas supply source 82 may be comprised of a gas storage tank and a feeding pump which are provided in the heat treatment apparatus 1 or may employ a utility system in a factory in which the heat treatment apparatus 1 is installed. The treatment gas is not limited to nitrogen gas, but may be inert gases such as argon (Ar) and helium (He), and reactive gases such as oxygen (O₂), hydrogen (H₂), chlorine (Cl₂), hydrogen chloride (HCl), ozone (O₃) and ammonia (NH₃).

The exhaust part 85 includes an exhaust device 87 and an exhaust valve 88 which are mounted to a gas exhaust pipe 86. The gas exhaust pipe 86 has a distal end in communication with the heat treatment space 65 in the chamber 6, and a proximal end connected to the exhaust device 87. By opening the exhaust valve 88 while the exhaust device 87 is in operation, the atmosphere in the heat treatment space 65 is exhausted. A vacuum pump and a utility exhaust system in a factory in which the heat treatment apparatus 1 is installed may be used as the exhaust device 87.

The heat treatment apparatus 1 further includes a susceptor 70 and lifting drives 20. The susceptor 70 is a substantially rectangular plate-like member made of quartz. The longitudinal and transverse dimensions (length and width) of the susceptor 70 are greater than the diameter of the semiconductor wafer W to be treated (for example, the longitudinal and transverse dimensions of the susceptor 70 are greater than 450 mm when the semiconductor wafer W has a diameter of 450 mm). On the other hand, the susceptor 70 is smaller in size as seen in plan view than the heat treatment space 65 in the chamber 6.

FIG. 3 is a sectional view of the susceptor 70. As shown in FIGS. 2 and 3, the susceptor 70 has a wafer pocket 71 formed in the center of the upper surface thereof. The wafer pocket 71 is a circular recess having a diameter slightly greater than that of the semiconductor wafer W. The wafer pocket 71 has a peripheral edge portion in the form of a tapered surface (FIG. 3).

A plurality of support pins (second support pins) 72 are mounted upright on the bottom surface of the wafer pocket 71. In the present preferred embodiment, a total of four support pins 72 mounted upright are disposed at intervals of 90 degrees along the circumference of a circle concentric with the circular wafer pocket 71. The diameter (a distance between opposed ones of the support pins 72) of the circle on which the four support pins 72 are disposed is less than the diameter of the semiconductor wafer W. The support pins 72 are made of quartz. The support pins 72 have a length (a distance between lower and upper ends thereof) of not greater than 10 mm. The support pins 72 and the susceptor 70 may be machined integrally. Alternatively, the support pins 72 separately formed may be welded to the susceptor 70.

When the semiconductor wafer W is held by the susceptor 70, the lower surface of the semiconductor wafer W is supported in point contacting relationship by the four support pins 72 mounted upright in the wafer pocket 71. The depth of the wafer pocket 71 is greater than the height of the support pins 72. Thus, the tapered surface in the peripheral edge portion of the wafer pocket 71 prevents the semiconductor wafer W supported by the support pins 72 from being out of position.

The susceptor 70 has four through holes 73 bored therein so as to extend vertically through the susceptor 70. The four through holes 73 are provided in the bottom surface of the wafer pocket 71. The through holes 73 are holes for wafer pins 12 to be described later to pass therethrough.

In the heat treatment apparatus 1 according to the present invention, the susceptor 70 is moved upwardly and downwardly in the chamber 6 by the lifting drives 20. One of the lifting drives 20 is provided on the (−Y) side of the chamber 6, and the other lifting drive 20 is provided on the (+Y) side thereof. That is, the two lifting drives 20 support the susceptor 70 on opposite sides to move the susceptor 70 upwardly and downwardly.

Each of the lifting drives 20 includes a drive motor 21, a support plate 22 and a support shaft 23. The support plate 22 is a plate made of metal, and has a distal end fastened with a bolt and a nut to an edge of the susceptor 70. The support shaft 23 is coupled to the lower surface of the support plate 22. The drive motor 21 moves the support shaft 23 upwardly and downwardly to thereby move the support plate 22 upwardly and downwardly in a vertical direction (along the Z axis). An example of a mechanism used herein in which the drive motor 21 moves the support shaft 23 upwardly and downwardly includes a ball screw mechanism in which the drive motor 21 rotates a ball screw in threaded engagement with a member coupled to the lower end of the support shaft 23. A pulse motor capable of accurate positioning control is preferably used as the drive motor 21. An encoder is preferably mounted to the drive motor 21 to detect the vertical position of the susceptor 70.

As shown in FIG. 1, the lifting drives 20 except distal end portions of the respective support plates 22 are provided outside the chamber side wall portion 61 of the chamber 6. The support plates 22 extend through openings formed in the chamber side wall portion 61 on the (−Y) and (+Y) sides. For the purpose of maintaining the hermeticity of the heat treatment space 65, an enclosure 24 covers the openings on opposite sides of the chamber side wall portion 61 through which the support plates 22 extend. The lifting drives 20 are housed in the enclosure 24. This closes off the communication of atmosphere between the outside of the heat treatment apparatus 1 and the heat treatment space 65. The support shafts 23 and the like are preferably covered with bellows for the purpose of preventing particles or dust generated from the lifting drives 20 themselves from flowing into the heat treatment space 65.

The drive motors 21 of the two lifting drives 20 provided on the (−Y) and (+Y) sides of the chamber 6 move the support plates 22 upwardly and downwardly in synchronism with each other. Thus, while being held in a horizontal attitude (an attitude such that the normal to the susceptor 70 coincides with a vertical direction) in the chamber 6, the susceptor 70 is moved upwardly and downwardly in a vertical direction by the two lifting drives 20.

The heat treatment apparatus 1 further includes the plurality of wafer pins (first support pins) 12 for supporting the semiconductor wafer W in the chamber 6. In the present preferred embodiment, the four wafer pins 12 are mounted upright on the upper surface of the lower chamber window 64 made of quartz. The wafer pins 12 are made of quartz. The wafer pins 12 have a length of tens of millimeters. Thus, the length of the support pins 72 of the susceptor 70 is less than that of the wafer pins 12. The four wafer pins 12 may be directly welded to the lower chamber window 64. Alternatively, recesses may be provided in the upper surface of the lower chamber window 64 so that the wafer pins 12 are removably mounted to the recesses. In either case, the position of the four wafer pins 12 in a horizontal plane and the vertical position thereof inside the chamber 6 are fixed.

When the susceptor 70 is moved downwardly by the lifting drives 20, the four wafer pins 12 pass through the through holes 73 bored in the susceptor 70, so that the upper ends of the wafer pins 12 protrude from the upper surface of the susceptor 70. At this time, when a semiconductor wafer W is held in the wafer pocket 71 of the susceptor 70, the four wafer pins 12 thrust the semiconductor wafer W upwardly to support the semiconductor wafer W. On the other hand, when the susceptor 70 is moved upwardly, with a semiconductor wafer W supported by the four wafer pins 12 protruding from the upper surface of the susceptor 70, the semiconductor wafer W is transferred to the wafer pocket 71 and held therein. In this manner, a semiconductor wafer W is transferred between the four wafer pins 12 and the susceptor 70.

FIG. 4 is a view showing a positional relationship between the wafer pins 12 and the support pins 72 of the susceptor 70. In the present preferred embodiment, when the four wafer pins 12 and the four support pins 72 are at the same vertical position (more strictly speaking, when the upper ends of the wafer pins 12 and the upper ends of the support pins 72 are at the same vertical position), the four wafer pins 12 and the four support pins 72 are disposed concyclically, i.e. on the circumference of a common circle.

The four wafer pins 12 and the four support pins 72 are disposed on the circumference of the aforementioned circle in an alternating manner at equal intervals. As mentioned above, the four support pins 72 are disposed at intervals of 90 degrees in the wafer pocket 71 of the susceptor 70. The four wafer pins 12, on the other hand, are disposed at intervals of 90 degrees on the lower chamber window 64. The four wafer pins 12 and the four support pins 72 are arranged on the circumference of the aforementioned circle in an alternating manner at equal intervals, i.e. at intervals of 45 degrees. Of course, the four through holes 73 through which the wafer pins 12 pass are bored in the susceptor 70 so as to be disposed on the circumference of the aforementioned circle at intervals of 90 degrees.

Referring again to FIG. 1, the flash heating part 5 provided over the chamber 6 includes an enclosure 51, a light source provided inside the enclosure 51 and including the multiple (in this preferred embodiment, 30) xenon flash lamps FL, and a reflector 52 provided inside the enclosure 51 so as to cover the light source from above. The flash heating part 5 further includes a lamp light radiation window 53 mounted to the bottom of the enclosure 51. The lamp light radiation window 53 forming the floor of the flash heating part 5 is a plate-like quartz window made of quartz. The flash heating part 5 is provided over the chamber 6, whereby the lamp light radiation window 53 is opposed to the upper chamber window 63. The flash lamps FL direct a flash of light from over the chamber 6 through the lamp light radiation window 53 and the upper chamber window 63 toward the heat treatment space 65.

The flash lamps FL, each of which is a rod-shaped lamp having an elongated cylindrical shape, are arranged in a plane so that the longitudinal directions of the respective flash lamps FL are in parallel with each other in a horizontal direction. Thus, a plane defined by the arrangement of the flash lamps FL is also a horizontal plane.

Each of the xenon flash lamps FL includes a rod-shaped glass tube (discharge tube) containing xenon gas sealed therein and having positive and negative electrodes provided on opposite ends thereof and connected to a capacitor, and a trigger electrode attached to the outer peripheral surface of the glass tube. Because the xenon gas is electrically insulative, no current flows in the glass tube in a normal state even if electrical charge is stored in the capacitor. However, if a high voltage is applied to the trigger electrode to produce an electrical breakdown, electricity stored in the capacitor flows momentarily in the glass tube, and xenon atoms or molecules are excited at this time to cause light emission. Such a xenon flash lamp FL has the property of being capable of emitting extremely intense light as compared with a light source that stays lit continuously such as a halogen lamp HL because the electrostatic energy previously stored in the capacitor is converted into an ultrashort light pulse ranging from 0.1 to 100 milliseconds. Thus, the flash lamps FL are pulsed light emitting lamps which emit light instantaneously for an extremely short time period less than one second.

The reflector 52 is provided over the plurality of flash lamps FL so as to cover all of the flash lamps FL. A fundamental function of the reflector 52 is to reflect flashes of light emitted from the plurality of flash lamps FL toward the heat treatment space 65. The reflector 52 is a plate made of an aluminum alloy. A surface of the reflector 52 (a surface which faces the flash lamps FL) is roughened by abrasive blasting.

The halogen heating part 4 provided under the chamber 6 includes an enclosure 41 incorporating the multiple (in the present preferred embodiment, 40) halogen lamps HL. The halogen heating part 4 directs light from under the chamber 6 through the lower chamber window 64 toward the heat treatment space 65 by means of the halogen lamps HL.

FIG. 5 is a plan view showing an arrangement of the multiple halogen lamps HL. In the present preferred embodiment, 20 halogen lamps HL are arranged in an upper tier, and 20 halogen lamps HL are arranged in a lower tier. Each of the halogen lamps HL is a rod-shaped lamp having an elongated cylindrical shape. The 20 halogen lamps HL in each of the upper and lower tiers are arranged so that the longitudinal directions thereof are in parallel with each other in a horizontal direction. Thus, a plane defined by the arrangement of the halogen lamps HL in each of the upper and lower tiers is also a horizontal plane.

As shown in FIG. 5, the halogen lamps HL in each of the upper and lower tiers are disposed at a higher density in a region opposed to the peripheral portion of the semiconductor wafer W supported by the susceptor 70 or the wafer pins 12 than in a region opposed to the central portion thereof. In other words, the halogen lamps HL in each of the upper and lower tiers are arranged at shorter intervals in the peripheral portion of the lamp arrangement than in the central portion thereof. This allows a greater amount of light to impinge upon the peripheral portion of the semiconductor wafer W where a temperature decrease is prone to occur when the semiconductor wafer W is heated by the irradiation thereof with light from the halogen heating part 4.

The group of halogen lamps HL in the upper tier and the group of halogen lamps HL in the lower tier are arranged to intersect each other in a lattice pattern. In other words, the 40 halogen lamps HL in total are disposed so that the longitudinal direction of the halogen lamps HL in the upper tier and the longitudinal direction of the halogen lamps HL in the lower tier are orthogonal to each other.

Each of the halogen lamps HL is a filament-type light source which passes current through a filament disposed in a glass tube to make the filament incandescent, thereby emitting light. A gas prepared by introducing a halogen element (iodine, bromine and the like) in trace amounts into an inert gas such as nitrogen, argon and the like is sealed in the glass tube. The introduction of the halogen element allows the temperature of the filament to be set at a high temperature while suppressing a break in the filament. Thus, the halogen lamps HL have the properties of having a longer life than typical incandescent lamps and being capable of continuously emitting intense light. Thus, the halogen lamps HL are continuously lighted lamps which emit light continuously at least for a time period of not less than one second. In addition, the halogen lamps HL, which are rod-shaped lamps, have a long life. The arrangement of the halogen lamps HL in a horizontal direction provides good efficiency of radiation toward the semiconductor wafer W provided over the halogen lamps HL.

The controller 3 controls the aforementioned various operating mechanisms provided in the heat treatment apparatus 1. The controller 3 is similar in hardware configuration to a typical computer. Specifically, the controller 3 includes a CPU for performing various computation processes, a ROM or read-only memory for storing a basic program therein, a RAM or readable/writable memory for storing various pieces of information therein, and a magnetic disk for storing control software, data and the like therein. The CPU in the controller 3 executes a predetermined processing program, whereby the processes in the heat treatment apparatus 1 proceed.

The heat treatment apparatus 1 further includes, in addition to the aforementioned components, various cooling structures to prevent an excessive temperature increase in the halogen heating part 4, the flash heating part 5 and the chamber 6 because of the heat energy generated from the halogen lamps HL and the flash lamps FL during the heat treatment of a semiconductor wafer W. As an example, a water cooling tube (not shown) is provided in the chamber side wall portion 61. The halogen heating part 4 and the flash heating part 5 have an air cooling structure for forming a gas flow therein to exhaust heat. Air is supplied to a gap between the upper chamber window 63 and the lamp light radiation window 53 to cool down the flash heating part 5 and the upper chamber window 63. Also, a temperature sensor (for example, a radiation thermometer which measures temperature in a non-contacting manner) which measures the temperature of the semiconductor wafer W supported by the susceptor 70 or the wafer pins 12 is provided in the chamber 6.

Next, a procedure for the treatment of a semiconductor wafer W in the heat treatment apparatus 1 will be described. A semiconductor wafer W to be treated herein is a semiconductor substrate doped with impurities (ions) by an ion implantation process. The impurities are activated by the heat treatment apparatus 1 performing the process of heating (annealing) the semiconductor wafer W by irradiation with a flash of light. The procedure for the treatment in the heat treatment apparatus 1 which will be described below proceeds under the control of the controller 3 over the operating mechanisms of the heat treatment apparatus 1.

FIG. 6 is a flow diagram showing the procedure for the treatment of a semiconductor wafer W in the heat treatment apparatus 1. FIGS. 7 to 9 are views each schematically showing a state of the semiconductor wafer W in the heat treatment apparatus 1 in one of the steps of FIG. 6.

First, the transport opening 66 of the chamber 6 is opened. A transport robot outside the heat treatment apparatus 1 transports a semiconductor wafer W implanted with impurity ions through the transport opening 66 into the heat treatment space 65 in the chamber 6 (in Step S1). At this time, the susceptor 70 is in a lowered position where the four wafer pins 12 pass through the through holes 73, so that the upper ends of the wafer pins 12 protrude from the upper surface of the susceptor 70.

The semiconductor wafer W transported into the heat treatment space 65 by the transport robot is moved forward to a position lying immediately over the wafer pocket 71 of the susceptor 70 and is stopped thereat. The transport robot moves downwardly, so that the semiconductor wafer W is transferred from the transport robot to the four wafer pins 12 and is placed on the four wafer pins 12 (in Step S2). FIG. 7 is a view showing that the semiconductor wafer W transported in the chamber 6 is placed on the wafer pins 12. At this time, the susceptor 70 is at a vertical position between the semiconductor wafer W placed on the wafer pins 12 and the lower chamber window 64, and the wafer pins 12 pass through the through holes 73. The semiconductor wafer W is supported by the four wafer pins 12 in such an attitude that a surface thereof which is patterned and implanted with impurities is the upper surface.

After the semiconductor wafer W is placed on the wafer pins 12, the transport robot moves out of the heat treatment space 65, and the transport opening 66 is closed by the gate valve. The replacement of an atmosphere within the chamber 6 is performed by the gas supply part 80 and the exhaust part 85. When the supply valve 83 of the gas supply part 80 is opened, nitrogen gas is supplied into the heat treatment space 65 in the chamber 6. By opening the exhaust valve 88 while the exhaust device 87 of the exhaust part 85 is in operation, the gas within the chamber 6 is exhausted. Thus, an atmosphere of air in the heat treatment space 65 in the chamber 6 is replaced with a nitrogen atmosphere. For the purpose of minimizing the outside atmosphere flowing into the heat treatment space 65 during the transport of the semiconductor wafer W into the heat treatment space 65, the supply of the nitrogen gas into the chamber 6 may be started before the transport opening 66 is opened.

Next, the 40 halogen lamps HL in the halogen heating part 4 turn on simultaneously to start preheating (or assist-heating) (in Step S3). Halogen light emitted from the halogen lamps HL is transmitted through the lower chamber window 64 and the susceptor 70 both made of quartz, and impinges upon the lower surface of the semiconductor wafer W (in the present preferred embodiment, the back surface of the semiconductor wafer W). The semiconductor wafer W is preheated by being irradiated with the halogen light from the halogen lamps HL, so that the temperature of the semiconductor wafer W increases. The four wafer pins 12, which are fixed on the lower chamber window 64 but are made of quartz, do not become obstacles to the process of heating the semiconductor wafer W by irradiation with light.

The temperature of the semiconductor wafer W is measured with a temperature sensor not shown when the halogen lamps HL perform the preheating. The temperature of the semiconductor wafer W measured with the temperature sensor is transmitted to the controller 3. The controller 3 exercises feedback control of the output from the halogen lamps HL, based on the result of measurement with the temperature sensor. The controller 3 controls the temperature of the semiconductor wafer W, for example, under PID (Proportional, Integral, Derivative) control.

The controller 3 monitors whether the temperature of the semiconductor wafer W which is on the increase by the irradiation with light from the halogen lamps HL reaches a predetermined preheating temperature T1 or not. The preheating temperature T1 shall be on the order of 200° to 800° C., preferably on the order of 350° to 600° C., (in the present preferred embodiment, 600° C.) at which there is no apprehension that the impurities implanted in the semiconductor wafer W are diffused by heat.

After the temperature of the semiconductor wafer W reaches the preheating temperature T1, the controller 3 maintains the temperature of the semiconductor wafer W at the preheating temperature T1 for a short time. Specifically, at the time when the temperature of the semiconductor wafer W measured with the temperature sensor reaches the preheating temperature T1, the controller 3 adjusts the output from the halogen lamps HL to maintain the temperature of the semiconductor wafer W at approximately the preheating temperature T1.

In the present preferred embodiment, the semiconductor wafer W is shifted between the wafer pins 12 and the support pins 72 of the susceptor 70 during the preheating process including the steps of increasing the temperature and maintaining the temperature. Specifically, the susceptor 70 is moved upwardly and downwardly repeatedly, so that the semiconductor wafer W is supported alternately by the wafer pins 12 and the susceptor 70.

When the controller 3 controls the lifting drives 20 to move the susceptor 70 downwardly, the upper ends of the wafer pins 12 protrude upwardly above the upper ends of the support pins 72 of the susceptor 70. At this time, the semiconductor wafer W is supported by the four wafer pins 12 (in Step S4). FIG. 8 is a view showing that the semiconductor wafer W is supported by the wafer pins 12. In this state, the four wafer pins 12 are in point contact with four places of the lower surface of the semiconductor wafer W.

On the other hand, when the controller 3 controls the lifting drives 20 to move the susceptor 70 upwardly, the support pins 72 of the susceptor 70 are above the wafer pins 12. At this time, the semiconductor wafer W is supported by the four support pins 72 of the susceptor 70 (in Step S5). FIG. 9 is a view showing that the semiconductor wafer W is supported by the support pins 72 of the susceptor 70. In this state, the four support pins 72 are in point contact with four places of the lower surface of the semiconductor wafer W.

As shown in FIG. 4, the four wafer pins 12 and the four support pins 72 are disposed concyclically in an alternating manner at intervals of 45 degrees. Thus, portions of the semiconductor wafer W with which the four wafer pins 12 come in contact as shown in FIG. 8 differ from portions of the semiconductor wafer W with which the four support pins 72 come in contact as shown in FIG. 9.

The process of supporting the semiconductor wafer W by means of the wafer pins 12 in Step S4 and the process of supporting the semiconductor wafer W by means of the support pins 72 in Step S5 are repeated until a predetermined time period has elapsed since the start of the preheating using the halogen lamps HL (in Step S6). In other words, the semiconductor wafer W is shifted between the wafer pins 12 and the support pins 72 of the susceptor 70 during the preheating performed by irradiation with light from the halogen lamps HL. The shifting of the semiconductor wafer W may be performed at appropriate time intervals.

By performing such preheating using the halogen lamps HL, the temperature of the entire semiconductor wafer W is uniformly increased to the preheating temperature T1. In the stage of preheating using the halogen lamps HL, the semiconductor wafer W shows a tendency to be lower in temperature in a peripheral portion thereof where heat dissipation is more liable to occur than in a central portion thereof. However, the halogen lamps HL in the halogen heating part 4 are disposed at a higher density in the region opposed to the peripheral portion of the semiconductor wafer W than in the region opposed to the central portion thereof. This causes a greater amount of light to impinge upon the peripheral portion of the semiconductor wafer W where heat dissipation is liable to occur, thereby providing a uniform in-plane temperature distribution of the semiconductor wafer W in the stage of preheating.

In particular, the semiconductor wafer W is shifted between the wafer pins 12 and the support pins 72 of the susceptor 70 during the preheating in the present preferred embodiment. The susceptor 70 including the support pins 72 and the wafer pins 12 are made of quartz which allows most of the light emitted from the halogen lamps HL to pass therethrough. Quartz slightly absorbs light from the halogen lamps HL, but components of light in such a wavelength region are absorbed by the lower chamber window 64 which is also made of quartz. For this reason, the wafer pins 12 and the support pins 72 absorb the light from the halogen lamps HL very little. Accordingly, the temperature of the wafer pins 12 and the support pins 72 increases very little when the temperature of the semiconductor wafer W irradiated with light from the halogen lamps HL is on the increase. Thus, there is a danger that the conduction of heat from the semiconductor wafer W to the pins made of quartz occurs in the places of the semiconductor wafer W with which the wafer pins 12 or the support pins 72 which are relatively low in temperature are in contact to result in a local temperature decrease near the contacting places.

In the present preferred embodiment, the semiconductor wafer W is shifted between the wafer pins 12 and the support pins 72 of the susceptor 70 during the preheating. Thus, different places of the semiconductor wafer W are periodically brought into contact with the quartz pins (the wafer pins 12 and the support pins 72). This alleviates the local temperature decrease at the places of contact between the semiconductor wafer W and the quartz pins during the process of heating the semiconductor wafer W by irradiation with light from the halogen lamps HL to improve the uniformity of the in-plane temperature distribution of the semiconductor wafer W.

Upon the lapse of the predetermined time period since the start of the preheating using the halogen lamps HL, the procedure proceeds from Step S6 to Step S7. The controller 3 controls the lifting drives 20 to move the susceptor 70 upwardly, so that the semiconductor wafer W the temperature of which is increased to the preheating temperature T1 is supported by the susceptor 70. At this time, the four support pins 72 of the susceptor 70 support the semiconductor wafer W (in a manner similar to that shown in FIG. 9).

After the semiconductor wafer W the temperature of which is increased to the preheating temperature T1 is supported by the susceptor 70, the front surface of the semiconductor wafer W is irradiated with a flash of light from the flash lamps FL of the flash heating part 5 (in Step S8). At this time, part of the flash of light emitted from the flash lamps FL travels directly toward the interior of the chamber 6. The remainder of the flash of light is reflected once from the reflector 52, and then travels toward the interior of the chamber 6. The irradiation of the semiconductor wafer W with such flashes of light achieves the flash heating of the semiconductor wafer W.

The flash heating, which is achieved by the emission of a flash of light from the flash lamps FL, is capable of increasing the temperature of the front surface of the semiconductor wafer W in a short time. Specifically, the flash of light emitted from the flash lamps FL is an intense flash of light emitted for an extremely short period of time ranging from about 0.1 to about 100 milliseconds as a result of the conversion of the electrostatic energy previously stored in the capacitor into such an ultrashort light pulse. The temperature of the front surface of the semiconductor wafer W subjected to the flash heating by the flash irradiation from the flash lamps FL momentarily increases to a treatment temperature T2 of 1000° C. or higher. After the impurities implanted in the semiconductor wafer W are activated, the temperature of the front surface of the semiconductor wafer W decreases rapidly. Because of the capability of increasing and decreasing the temperature of the front surface of the semiconductor wafer W in an extremely short time, the heat treatment apparatus 1 achieves the activation of the impurities implanted in the semiconductor wafer W while suppressing the diffusion of the impurities due to heat. It should be noted that the time required for the activation of the impurities is extremely short as compared with the time required for the thermal diffusion of the impurities. Thus, the activation is completed in a short time ranging from about 0.1 to about 100 milliseconds during which no diffusion occurs.

Such flash heating is performed while the semiconductor wafer W is supported by the support pins 72 of the susceptor 70. The length of the support pins 72 of the susceptor 70 is less than that of the wafer pins 12. The temperature of the upper surface of the semiconductor wafer W is momentarily increased to the treatment temperature T2 of 1000° C. or higher by the flash irradiation, whereas the temperature of the lower surface of the semiconductor wafer W is not so much increased from the preheating temperature T1 at that moment. In other words, a large temperature difference arises momentarily between the upper and lower surfaces of the semiconductor wafer W. As a result, the abrupt thermal expansion of only the upper surface of the semiconductor wafer W occurs, whereas the thermal expansion of the lower surface thereof occurs very little. Thus, the semiconductor wafer W momentarily warps in such a manner that the upper surface thereof is convex upward. The occurrence of such momentary warpage gives an impact to the pins supporting the semiconductor wafer W. The support pins 72 which are shorter in length than the wafer pins 12 have higher resistance to the momentary impact given from the semiconductor wafer W. Thus, the irradiation of the semiconductor wafer W supported by the shorter support pins 72 of the susceptor 70 with a flash of light from the flash lamps FL as in the present preferred embodiment prevents breakage of the support pins 72 even when the momentary warpage occurs in the semiconductor wafer W.

After a predetermined time period has elapsed since the completion of the flash heating treatment, the halogen lamps HL turn off. This causes the temperature of the semiconductor wafer W to decrease rapidly from the preheating temperature T1. The susceptor 70 supporting the semiconductor wafer W moves downwardly to transfer the semiconductor wafer W from the support pins 72 to the wafer pins 12. The state at this time is similar to that shown in FIG. 7 at the time when the semiconductor wafer W is transported into the chamber 6.

Then, after the temperature of the semiconductor wafer W decreases to a predetermined temperature or below, the transport opening 66 of the chamber 6 is opened, and the transport robot outside the heat treatment apparatus 1 transports the semiconductor wafer W placed on the wafer pins 12 out of the chamber 6. Thus, the process of heating the semiconductor wafer W in the heat treatment apparatus 1 is completed (in Step S9).

During the process of preheating the semiconductor wafer W by irradiating the semiconductor wafer W with light from the halogen lamps HL, the susceptor 70 is moved upwardly and downwardly, so that the semiconductor wafer W is shifted between the wafer pins 12 and the support pins 72 of the susceptor 70 in the present preferred embodiment. This prevents the quartz pins which are relatively low in temperature without absorbing light from being continuously kept in contact with particular places of the semiconductor wafer W to alleviate the local temperature decrease in the places where the semiconductor wafer W and the quartz pins are in contact with each other during the preheating, thereby improving the uniformity of the in-plane temperature distribution of the semiconductor wafer W.

During the irradiation of the semiconductor wafer W with a flash of light from the flash lamps FL, the semiconductor wafer W is supported by the support pins 72 of the susceptor 70. If momentary warpage occurs in the semiconductor wafer W during the irradiation with a flash of light, breakage of the support pins 72 due to an impact to the support pins 72 is prevented because the support pins 72 which are shorter in length than the wafer pins 12 support the semiconductor wafer W.

While the preferred embodiment according to the present invention has been described hereinabove, various modifications of the present invention in addition to those described above may be made without departing from the scope and spirit of the invention. For example, the four wafer pins 12 and the four support pins 72 of the susceptor 70 are disposed concyclically in the aforementioned preferred embodiment. The present invention, however, is not limited to this. An arrangement as shown in FIG. 10 may be employed. FIG. 10 is a view showing another example of the positional relationship between the wafer pins 12 and the support pins 72 of the susceptor 70. In the example of FIG. 10, when the four wafer pins 12 and the four support pins 72 are at the same vertical position, the four wafer pins 12 and the four support pins 72 are provided on the circumferences of different circles.

As shown in FIG. 10, a circle (first circle) 95 on which the four wafer pins 12 are disposed and a circle (second circle) 96 on which the four support pins 72 are disposed are concentric circles. Both of the circles 95 and 96 are concentric with the wafer pocket 71 of the susceptor 70. The circle 95 on which the four wafer pins 12 are disposed has a diameter less than that of the circle 96 on which the four support pins 72 are disposed. Such an arrangement as shown in FIG. 10 is employed for the following reason. The four wafer pins 12 are used also for the transfer of the semiconductor wafer W to and from the transport robot outside the heat treatment apparatus 1. Even if the semiconductor wafer W is out of position during the treatment, the arrangement as shown in FIG. 10 allows the four wafer pins 12 to support the semiconductor wafer W with reliability.

The four wafer pins 12 are spaced at intervals of 90 degrees on the circumference of the inner circle 95. On the other hand, the four support pins 72 are spaced at intervals of 90 degrees on the circumference of the outer circle 96. The four wafer pins 12 and the four support pins 72 are disposed in an alternating manner at equal intervals, i.e. at intervals of 45 degrees, as seen from the center of the inner and outer circles 95 and 96.

When the arrangement shown in FIG. 10 is employed, the semiconductor wafer W is also shifted between the wafer pins 12 and the support pins 72 of the susceptor 70 during the process of heating the semiconductor wafer W by irradiating the semiconductor wafer W with light from the halogen lamps HL. This prevents the quartz pins which are relatively low in temperature without absorbing light from being continuously kept in contact with particular places of the semiconductor wafer W to alleviate the local temperature decrease in the places where the semiconductor wafer W and the quartz pins are in contact with each other during the preheating, thereby improving the uniformity of the in-plane temperature distribution of the semiconductor wafer W.

In the aforementioned preferred embodiment, the four wafer pins 12 and the four support pins 72 are provided. However, the number of wafer pins 12 and the number of support pins 72 are not limited to four. At least three wafer pins 12 and at least three support pins 72 capable of supporting the semiconductor wafer W may be provided. Preferably, the wafer pins 12 and the support pins 72 are disposed in an alternating manner at equal intervals so as to be as distant from each other as possible.

In the aforementioned preferred embodiment, the susceptor 70 is moved upwardly and downwardly, so that the semiconductor wafer W is shifted between the wafer pins 12 and the support pins 72 of the susceptor 70. In place of this, the wafer pins 12 may be moved upwardly and downwardly, so that a similar shifting operation is performed. Specifically, the four wafer pins 12 are mounted upright on an arm member made of quartz, and the arm member is moved upwardly and downwardly by a lifting drive (actuator and the like). This also allows the shifting of the semiconductor wafer W between the wafer pins 12 and the support pins 72 of the susceptor 70, thereby producing effects similar to those of the aforementioned preferred embodiment.

Further, both the susceptor 70 and the wafer pins 12 may be moved upwardly and downwardly, so that the semiconductor wafer W is shifted between the wafer pins 12 and the support pins 72 of the susceptor 70. In short, it is only necessary that the susceptor 70 is moved upwardly and downwardly relative to the wafer pins 12. When both the susceptor 70 and the wafer pins 12 are moved upwardly and downwardly, the semiconductor wafer W is treated while being supported at vertical positions suitable for the process of heating the semiconductor wafer W by irradiation with light from the halogen lamps HL and for the process of irradiating the semiconductor wafer W with a flash of light from the flash lamps FL.

In the aforementioned preferred embodiment, the flash heating part 5 is provided over the chamber 6 and the halogen heating part 4 is provided under the chamber 6. However, the positions of the flash heating part 5 and the halogen heating part 4 may be reversed. Also, the semiconductor wafer W may be inverted or flipped before being transported into the chamber 6. In these cases, the front surface of the semiconductor wafer W is irradiated with light from the halogen lamps HL, and the back surface thereof is irradiated with a flash of light from the flash lamps FL. The technique according to the present invention is also applicable to a heat treatment apparatus which heats a semiconductor wafer W by irradiating only the back surface or the front surface of the semiconductor wafer W with light from the halogen lamps HL without providing the flash lamps FL. In this case, the semiconductor wafer W may be shifted between the wafer pins 12 and the support pins 72 of the susceptor 70 during the process of heating the semiconductor wafer W by irradiating the semiconductor wafer W with light from the halogen lamps HL, whereby eliminated is the occurrence of the problem that the quartz pins which are relatively low in temperature are continuously kept in contact with particular places of the semiconductor wafer W. As a result, this alleviates the local temperature decrease at the places of contact between the semiconductor wafer W and the quartz pins during the process of heating the semiconductor wafer W by irradiation with light from the halogen lamps HL to improve the uniformity of the in-plane temperature distribution of the semiconductor wafer W.

Although the 30 flash lamps FL are provided in the flash heating part 5 according to the aforementioned preferred embodiment, the present invention is not limited to this. Any number of flash lamps FL may be provided. The flash lamps FL are not limited to the xenon flash lamps, but may be krypton flash lamps. Also, the number of halogen lamps HL provided in the halogen heating part 4 is not limited to 40. Any number of halogen lamps HL may be provided.

In the aforementioned preferred embodiment, the filament-type halogen lamps HL are used as the continuously lighted lamps which emit light continuously for a time period of not less than one second, and the flash lamps FL are used as the pulsed light emitting lamps which emit light for a time period less than one second. Instead, xenon arc lamps, for example, which are caused to emit light by electric discharge may be used as the continuously lighted lamps.

Moreover, a substrate to be treated by the heat treatment apparatus according to the present invention is not limited to a semiconductor wafer, but may be a glass substrate for use in a flat panel display for a liquid crystal display apparatus and the like, and a substrate for a solar cell. Also, the technique according to the present invention may be applied to the joining of metal and silicon, and to the crystallization of polysilicon.

While the invention has been described in detail, the foregoing description is in all aspects illustrative and not restrictive. It is understood that numerous other modifications and variations can be devised without departing from the scope of the invention.

What is claimed is:

1. A heat treatment apparatus for heating a substrate by irradiating the substrate with light, comprising:
a chamber for receiving a substrate therein;
a plurality of first support pins for supporting the substrate in said chamber;
a susceptor having a plurality of second support pins and for holding the substrate in said chamber;
a continuously lighted lamp for irradiating the substrate received in said chamber with light to heat the substrate;
a lifting drive for moving said susceptor upwardly and downwardly relative to said first support pins; and
a controller configured to control said lifting drive so that a first state and a second state are alternately repeated when the substrate is heated by the irradiation with light from said continuously lighted lamp, said first state being such that said susceptor is in a relatively lowered position so that said first support pins protrude above said second support pins to support said substrate, said second state being such that said susceptor is in a relatively raised position so that said second support pins lie above said first support pins to support said substrate.

2. The heat treatment apparatus according to claim 1, wherein
said first support pins and said second support pins are disposed concyclically in an alternating manner at equal intervals when said first support pins and said second support pins are at the same vertical position.

3. The heat treatment apparatus according to claim 1, wherein:
said second support pins are disposed on a second circle concentric with a first circle on which said first support pins are disposed when said first support pins and said second support pins are at the same vertical position; and
said first circle has a diameter less than that of said second circle.

4. The heat treatment apparatus according to claim 3, wherein
said first support pins and said second support pins are disposed in an alternating manner at equal angular intervals as seen from the center of said first and second circles.

5. The heat treatment apparatus according to claim 1, further comprising
a pulsed light emitting lamp for irradiating the substrate heated by said continuously lighted lamp with a flash of light,
wherein said second support pins have a length less than that of said first support pins, and
wherein said controller controls said lifting drive so that said second support pins support said substrate when said substrate is irradiated with a flash of light from said pulsed light emitting lamp.

6. A method of heating a substrate by irradiating the substrate with light, comprising the step of
moving a susceptor including a plurality of second support pins upwardly and downwardly relative to a plurality of first support pins provided in a chamber when heating the substrate received in said chamber by irradiating the substrate with light from a continuously lighted lamp,
said step of moving said susceptor comprising the substeps of:
a) bringing said susceptor in a relatively lowered position so that said first support pins protrude above said second support pins to support said substrate; and
b) bringing said susceptor in a relatively raised position so that said second support pins lie above said first support pins to support said substrate,
said substep a) and said substep b) being alternately repeated.

7. The method according to claim 6, wherein
said first support pins and said second support pins are disposed concyclically in an alternating manner at equal intervals when said first support pins and said second support pins are at the same vertical position.

8. The method according to claim 6, wherein:
said second support pins are disposed on a second circle concentric with a first circle on which said first support pins are disposed when said first support pins and said second support pins are at the same vertical position; and
said first circle has a diameter less than that of said second circle.

9. The method according to claim 8, wherein
said first support pins and said second support pins are disposed in an alternating manner at equal angular intervals as seen from the center of said first and second circles.

10. The method according to claim 6, further comprising the step of
irradiating the substrate heated by said continuously lighted lamp with a flash of light from a pulsed light emitting lamp,
wherein said second support pins have a length less than that of said first support pins, and
wherein said second support pins support said substrate when said substrate is irradiated with a flash of light from said pulsed light emitting lamp.
